(19) United States
(12) Patent Application Publication
(10) Pub. No.: US 2008/0113620 A1
(43) Pub. Date: May 15, 2008

(54) RADIO COMMUNICATION APPARATUS AND POWER CONTROL METHOD OF RADIO COMMUNICATION APPARATUS

(75) Inventor: Makoto Yamashita, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/938,183

(22) Filed: Nov. 9, 2007

(30) Foreign Application Priority Data
Nov. 10, 2006 (JP) P2006-305762

(51) Int. Cl. H04B 7/00

(52) U.S. Cl. 455/41.2

(57) ABSTRACT

According to one embodiment, a radio communication apparatus includes: a radio communication device connecting a communication link with an other radio communication equipment to perform radio communication therewith; a detection device determining the presence or absence of the other radio communication apparatus when the radio communication device is not connecting the communication link with the other radio communication apparatus; a power control device controlling to power off when the detection device detects the absence of the other radio-communicable communication apparatus and not to power off when the detection device detects the presence thereof.

### CROSS-REFERENCE TO RELATED APPLICATIONS

This application is based upon and claims the benefit of priority from Japanese Patent Application No. 2006-305762, filed Nov. 10, 2006, the entire contents of which are incorporated herein by reference.

### BACKGROUND

1. Field

One embodiment of the invention relates to a radio communication apparatus and a power control method of a radio communication apparatus.

2. Description of the Related Art

In recent years, it is known that, between communication equipment such as a personal computer and peripherals, an audio playback unit and wireless speaker(s) (or wireless earphone(s)) and so forth, data communication is performed based on a radio communication method such as Bluetooth (registered trademark). When the equipment of this type performs data communication, for example, when the wireless speaker is not receiving music data from the audio playback unit, namely when no communication link exists with the audio playback unit, the communication equipment is preferably automatically powered off for the purpose of suppressing wasteful power consumption. The art of automatically powering off the communication equipment for the purpose of suppressing wasteful power consumption as described above is disclosed, for example, in Japanese Patent Application Publication (KOKAI) No. 2006-115166 (Patent document 1)

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view showing a configuration of a radio communication system configured by radio communication apparatuses according to an embodiment of the invention;

FIG. 2 is an exemplary view showing a configuration of the radio communication system configured by the radio communication apparatuses in the embodiment;

FIG. 3 is an exemplary circuit diagram showing an electrical configuration of the radio communication apparatus in the embodiment;

FIG. 4 is an exemplary flowchart showing an auto power off process of the radio communication apparatus in the embodiment; and

FIG. 5 is an exemplary flowchart showing the auto power off process of the radio communication apparatus in a modification embodiment.

### DETAILED DESCRIPTION

Various embodiments of the invention will be described hereinafter with reference to the accompanying drawings.

In general, according to one embodiment of the invention, a radio communication apparatus includes: a radio communication device establishing a communication link with another radio communication equipment to perform radio communication therewith; a detection device configured to detect the presence or absence of the other radio communication apparatus when the communication link between the radio communication device and the other radio communication apparatus is not established¥; a power control device configured to power off when the detection device detects the absence of the other radio-communicable communication apparatus and not to power off when the detection device detects the presence thereof.

Further, a power control method of a radio communication apparatus performs a presence/absence detection detecting the presence or absence of another communication apparatus capable of performing radio communication when a radio communication device connecting a communication link with the other radio communication apparatus to perform radio communication therewith is not connecting the communication link therewith. The power control method powers off the apparatus when the presence/absence detection detects that the other radio communication apparatus capable of performing radio communication is absent and does not power when the other radio communication apparatus is detected to be present.

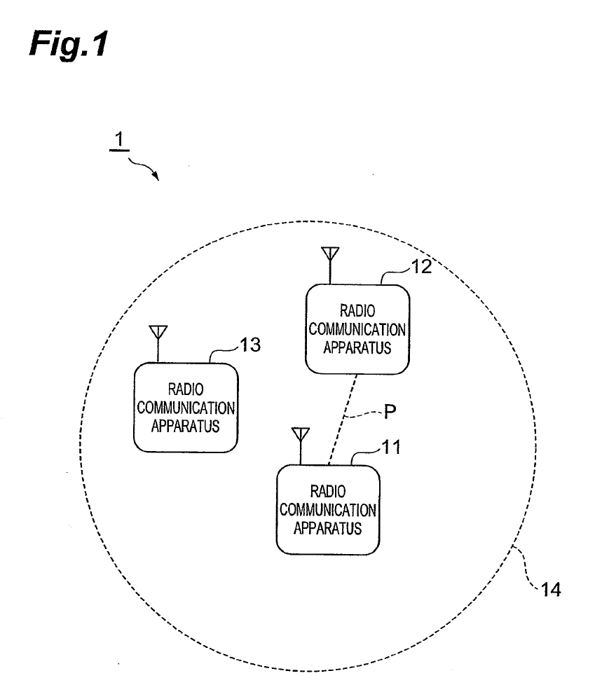

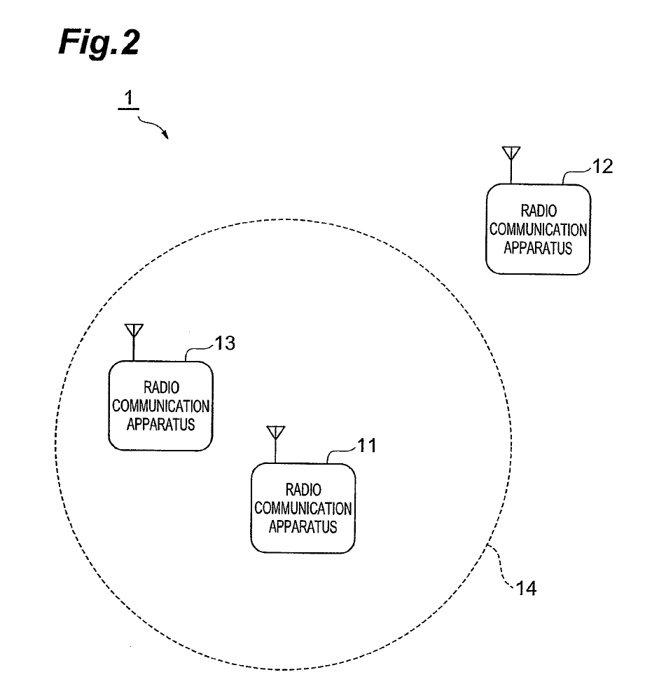

FIG. 1 and FIG. 2 are views showing a configuration of a radio communication system configured by radio communication apparatuses according to one embodiment of the invention. A radio communication system 1 shown in FIG. 1 and FIG. 2 includes: a radio communication apparatus 11 according to one embodiment and the other radio communication apparatuses 12, 13 capable of performing radio communication with the radio communication apparatus 11 based on a Bluetooth method.

It should be noted that the radio communication apparatus 11 and the radio communication apparatus 12 are assumed to be already authenticated mutually and can be connected to each other by a pairing P to perform radio communication, while the radio communication apparatus 11 and the radio communication apparatus 13 are assumed to be unpaired. The pairing is performed when the apparatuses are first connected, and once the pairing is performed, each radio communication apparatus paired holds a link key indicating that it is already paired. Accordingly, in this embodiment, it is assumed that the radio communication apparatus 11 holds the link key showing that it is already paired with the radio communication apparatus 12, and that the radio communication apparatus 12 holds the link key showing that it is already paired with the radio communication apparatus 11 as well. Specifically, the already-paired radio communication apparatus 12 can be considered to be the apparatus performing radio communication with the radio communication apparatus 11 with high probability, while the not-yet-paired radio communication apparatus 13 can be considered to be the apparatus performing radio communication with the radio communication apparatus 11 with low probability.

In FIG. 1, the radio communication apparatuses 12, 13 are present within a radio communication range 14 within which the radio communication apparatus 11 can radio communicate. Meanwhile, in FIG. 2, the radio communication apparatus 13 is present within the radio communication range 14, while the radio communication apparatus 12 is present outside the radio communication range 14.

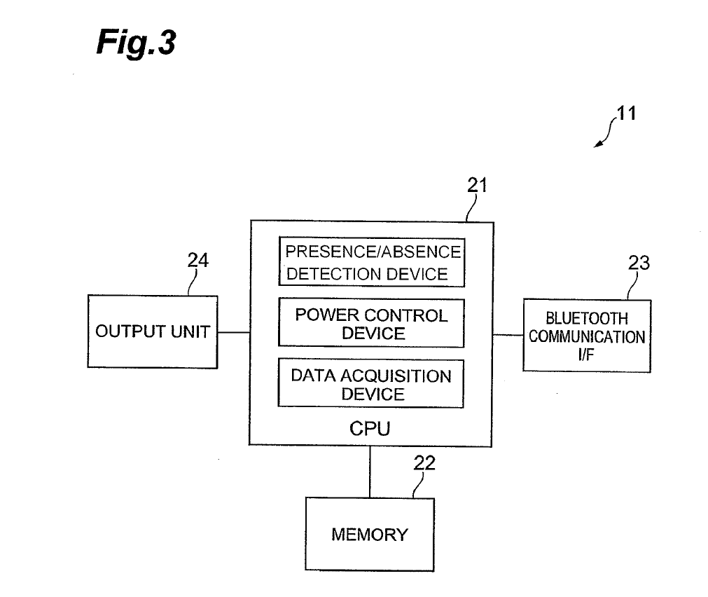

FIG. 3 is a circuit diagram showing an electrical configuration of the radio communication apparatus 11 according to the embodiment. Note that the electrical configuration of the other radio communication apparatus 12 is considered to be the same as well. The radio communication apparatus 11 and the radio communication apparatus 12 include a CPU (Central Processing Unit) 21 and a memory 22 storing a program for various applications to execute the program stored in the memory 22 by the CPU 21. Further, the radio communication apparatus 11 and the radio communication apparatus 12 include a Bluetooth communication I/F (interface) 23 connecting the communication link with the other radio communication apparatus to perform radio communication, respectively. As shown in FIG. 1, the radio communication apparatus 11 and the radio communication apparatus 12 establish a data communication link such as an ACL (Asynchronous Connectionless Link) or a sound communication link such as an SCO (Synchronous Connection Oriented Link) in the Bluetooth via the Bluetooth communication I/F 23 to perform communication and thereby activate the various applications.

Here, a case where the radio communication apparatus 11 is a wireless speaker and the radio communication apparatus 12 is an audio playback unit will be shown as an example. In this case, by a music streaming function such as an A2DP (Advanced Audio Distribution Profile), the radio communication apparatus 12 as an audio playback unit sends music data and the radio communication apparatus 11 as a wireless speaker receives the music data to reproduce and output from an output unit 24.

When the radio communication apparatus 12 stops reproducing the music, it is no longer necessary to send the music data backed by the music streaming function. The data communication link established between the two is therefore disconnected. Further, when the radio communication apparatus 12 is powered off, the communication link is disconnected. After that, in the wireless speaker 11, the CPU 21 serves as a detection device, a power control device and a data acquisition device, and an auto power off process is executed.

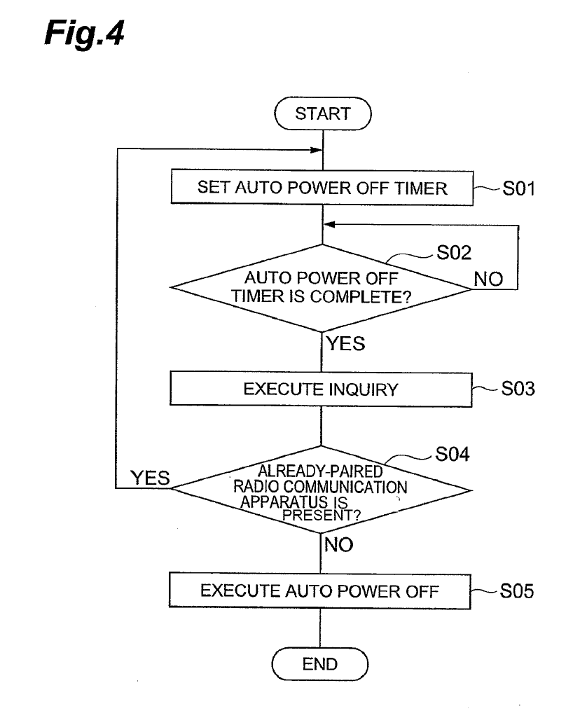

Hereinafter, the description will be given of the auto power off process of the radio communication apparatus 11 in detail and also of a power control method of the radio communication apparatus according to one embodiment. FIG. 4 is a flowchart showing the auto power off process of the radio communication apparatus 11.

After music data transmission from the radio communication apparatus 12 is stopped and the communication link for performing radio communication with the radio communication apparatus 12 is disconnected, namely, when no communication link is established with the radio communication apparatus 12, the radio communication apparatus 11 sets an auto power off timer measuring time until a power off previously set arbitrarily by the system is executed (S01). The value of the auto power off timer decreases over time.

Subsequently, the radio communication apparatus 11 determines whether or not the auto power off timer is complete, namely, whether or not the auto power off timer has reached 0 (zero) (S02). When the auto power off timer is determined to be incomplete, then the process returns to S02 again and continues to determine whether or not the auto power off timer is complete.

### (Data Acquisition Process)

Meanwhile, when the auto power off timer is determined to be complete, the CPU 21 in the radio communication apparatus 11 serves as a data acquisition device and executes an Inquiry (data acquisition process) to acquire data on the other radio communication apparatuses 12, 13 including the already-paired radio communication apparatus 12 present in the radio communication range 14 via the Bluetooth communication I/F 23 (S03). Note that, in the Bluetooth-based communication, “Inquiry” is a command sent to scan for nearby apparatuses, and the apparatus receiving the Inquiry command (for example, the other radio communication apparatuses 12, 13) returns an address of itself (a BD-ADDR being a 48-bit address given to each of the Bluetooth devices).

### (Presence/Absence Detection Process)

After that, the CPU 21 serves as a detection device and detects whether or not any radio communication apparatus in a radio communicable status is present using the result of the Inquiry in S03. Specifically, by referring to the address data acquired by the Inquiry and by determining whether or not it is already paired with the apparatus with the relevant address, the presence or the absence of the already-paired radio communication apparatus is detected (S04).

When the already-paired radio communication apparatus is detected to be present, namely when the already-paired radio communication apparatus 12 is present within the radio communication range 14 of the radio communication apparatus 11 as shown in FIG. 1, it is possible to consider that the communication with the radio communication apparatus 12 will be resumed with high probability in the future.

Meanwhile, when the already-paired radio communication apparatus is detected to be absent, namely when the already-paired radio communication apparatus 12 is not present within the radio communication range 14 of the radio communication apparatus 11 as shown in FIG. 2, or when the radio communication apparatus 12 in the state of FIG. 1 is powered off and not in the radio communicable state, it is possible to consider that the radio communication with the radio communication apparatus 12 will be resumed with low probability in the future, allowing the radio communication to be considered unnecessary.

### (Power Control Process)

Therefore, when the detection device detects that the radio communication apparatus 12 is present in the radio communication range 14 of the radio communication apparatus 11, the CPU 21 serves as a power control device and the process returns to S01 again without performing the power off process, setting an initial value to the auto power off timer. Meanwhile, when the detection device detects that the radio communication apparatus 12 is not present in the radio communication range 14 of the radio communication apparatus 11, the CPU 21 serves as a power control device to power off the apparatus (S05).

As described above, in this embodiment the CPU 21 serves as a detection device and detects whether or not the radio communication apparatus 12 in the radio communicable state (being already paired) is present, and only when it is determined that the radio communication apparatus 12 in the radio communicable state is not present, the CPU 21 serves as a power control device to turn off the power. Hence, with the power control as described above, the power consumption can be reduced while improving the user's ease of operation at the time of reuse.

In other words, in this embodiment when the radio communication apparatus 12 capable of performing radio communication is present, the CPU 21 serves as a power control device to automatically foresee that the communication link will be connected again to resume the data communication even when no communication link exists, so that the automatic power off can be suppressed. As a result, it is possible to prevent the case where the radio communication apparatus 11 is powered off and unable to activate the application for the radio communication immediately when the user wants to activate the application for the radio communication, so that user convenience can be improved.

Note that the invention is not limited to the above-described embodiments and can be modified in various manners. For instance, in one embodiment, the presence/absence of the radio communication apparatus capable of performing radio communication is detected based on the presence/absence of the already-paired radio communication apparatus, however, the detection of the presence/absence of the radio communication apparatus capable of performing the radio communication may be made based on the presence/absence of the reply to the Inquiry.

In addition to the above, the invention is also applicable to the case where a radio communication apparatus is present independently of the radio communication apparatuses 11 to 13, the case where the radio communication apparatus 11 is not a wireless speaker, and the case where the radio communication apparatus 12 is not an audio playback unit.

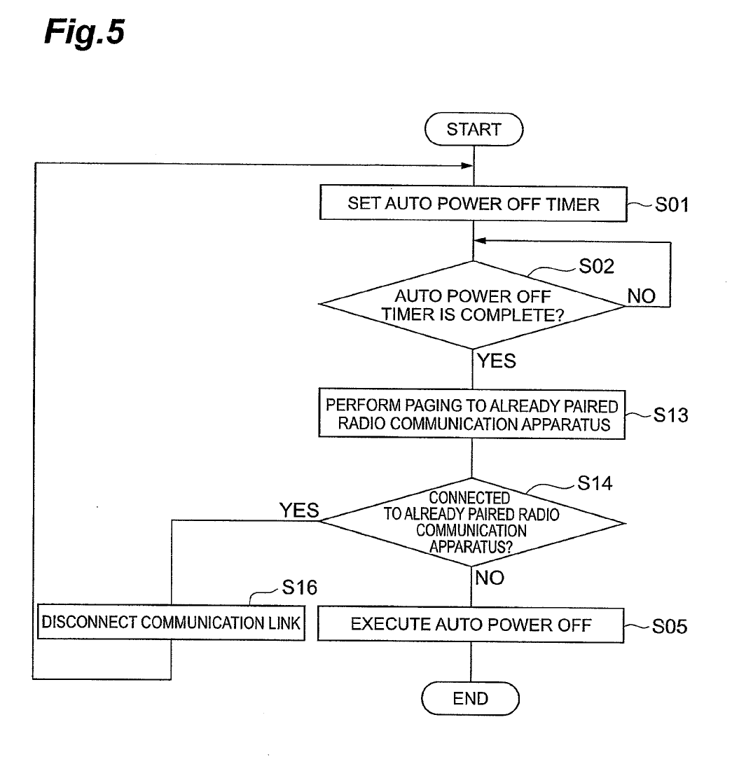

In one embodiment, in order to detect the presence/absence of the radio communication apparatus 12 capable of performing radio communication, the result of the Inquiry is used, however, the result of a Paging (communication link establishing process) may be used instead. FIG. 5 is a flowchart showing an auto power off process of a radio communication apparatus according to a modification embodiment. Hereinafter, the description will be given of an auto power off process of the radio communication apparatus 11 according to the modification embodiment in detail and also of a power control method of the radio communication apparatus according to the modification embodiment of the invention.

### (Communication Link Connecting Process)

As shown in FIG. 5, when it is determined that the auto power off timer is complete, the CPU 21 in the radio communication apparatus 11 serves as a communication link establishing device to execute the Paging, so that the radio communication link to the already-paired radio communication apparatus 12 is established via the Bluetooth communication I/F 23 (S13).

### (Presence/Absence Detection Process)

After that, the CPU 21 serves as a detection device to detect whether or not any radio communication apparatus in a radio communicable status is present using the result of the Paging in S13. Specifically, whether or not the radio communication link to the radio communication apparatus 12 is established is determined (S14).

When it is determined that the radio communication link is established, namely in the case where the already-paired radio communication apparatus 12 is present in the radio communication range 14 of the radio communication apparatus 11 as shown in FIG. 1, it is possible to consider that the communication with the radio communication apparatus 12 will be resumed with high probability in the future.

Meanwhile, when the radio communication is determined to be not established, namely in the case where the radio communication apparatus 12 is not present in the radio communication range 14 of the radio communication apparatus 11 or in the case where the radio communication cannot be performed due to, e.g. the powered-off state of the radio communication apparatus 12, it is possible to consider that the radio communication with the radio communication apparatus 12 will be resumed in the future with low probability, so that the radio communication can be considered unnecessary.

### (Power Control Process)

Therefore, when it is determined by the detection device that the already-paired radio communication apparatus 12 is present in the radio communication range 14 of the radio communication apparatus 11, the CPU 21 serves as a power control device, and the process returns to S01 again after the radio communication link connected for confirmation is disconnected (S16) without performing the power off process and sets an initial value to the auto power off timer. Meanwhile, when it is determined by the detection device that the radio communication apparatus 12 is not present in the radio communication range 14 of the radio communication apparatus 11, the CPU 21 itself serves as a power control device and executes the power off process (S05).

Further, in this embodiment, when the already-paired radio communication apparatus 12 is present in the radio communication range 14, it is determined that the communication will be resumed with high probability and the control does not power off However, even when the radio communication apparatus 12 is not-yet-paired, when the radio communication apparatus 12 is present in the radio communication range 14, it may be determined that the radio communication apparatus 12 will be paired to perform the communication with high probability and in such a case the control does not power off.

Further, in the above-described embodiments, the radio communication apparatus 11 performs the power control based on the detection of the single radio communication apparatus 12 in a radio communicable state, however, the power control may be performed based on the determination of the respective radio communicable states of a plurality of the radio communication apparatuses.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A radio communication apparatus comprising:
a radio communication device configured to establish a communication link with another radio communication apparatus to perform a radio communication therewith;
a detection device configured to detect the presence or absence of another radio communication apparatus capable of performing radio communication when the other radio communication apparatus is not connected via a communication link with the radio communication device; and
a power control device configured to power off the apparatus when the detection device detects the absence of the other radio communication apparatus capable of performing radio communication and not to power off when said detection device detects the presence thereof.

2. The radio communication apparatus according to claim 1, wherein the detection device is configured to detect the presence or the absence of an already-paired other radio communication apparatus within a radio communication range.

3. The radio communication apparatus according to claim 2, further comprising a data acquisition device configured to acquire data from the other radio communication apparatus, wherein said detection device is configured to determine the presence or absence using at least some of the acquired data.

4. The radio communication apparatus according to claim 2, further comprising a communication link establishing device configured to establish a communication link with the already-paired other radio communication apparatus, wherein said detection device is configured to detect the presence or the absence using a result of the communication link established by said communication link establishing device.

5. The radio communication apparatus according to claim 1, wherein said detection device is configured to detect the presence or the absence again after passage of a predetermined time following a detection that the other radio communication apparatus is present.

6. The radio communication apparatus according to claim 1,
wherein said radio communication apparatus is configured to perform radio communication based on Bluetooth.

7. A power control method of a radio communication apparatus comprising:
detecting the presence or absence of another radio communication apparatus capable of performing radio communication when a radio communication device configured to establish a communication link with another radio communication apparatus to perform radio communication therewith has not established the communication link with the other radio communication apparatus, and
powering off when the other radio communication apparatus is detected to be absent and not powering off when the other radio communication apparatus is detected to be present.

8. The power control method of the radio communication apparatus according to claim 7, wherein, detecting the presence or absence comprises detecting the presence or absence of an already-paired other radio communication apparatus within a radio communication range.
